(19) United States
(12) Patent Application Publication
(10) Pub. No.: US 2005/0175956 A1
(43) Pub. Date: Aug. 11, 2005

(54) Toothbrush for whitening teeth

(76) Inventors: Bruce M. Russell, Howell, NJ (US); Diego Hoic, Jersey City, NJ (US); Michael Prencipe, West Windsor, NJ (US)

Correspondence Address: COLGATE-PALMOLIVE COMPANY, 909 RIVER ROAD, PISCATAWAY, NJ, 08855, US

(21) Appl. No.: 10/776,554

(22) Filed: Feb. 11, 2004

(51) Int. Cl. A61C 3/00; A61C 5/00

(52) U.S. Cl. 433/29; 433/215

(57) ABSTRACT

A toothpaste formulation contains an oxidizing agent as a whitening ingredient. The activation of the oxidizing agent occurs through the use of a toothbrush having a source of light energy which includes LED's in the bristle field of the toothbrush. The toothbrush could be a manual toothbrush or a powered toothbrush.

### BACKGROUND OF THE INVENTION

Various techniques have been used for creating a whitening effect of a user's teeth. Current at home tooth whitening techniques require several days for the user to see the effect of the treatment and are generally considered to be inconvenient and in some cases difficult to use. A technique marketed by BriteSmile, Inc. involves providing a tooth whitening composition which includes an oxidizing compound which when applied to a stained tooth and exposed to actinic light is activated to facilitate tooth whitening. The light is provided by a device which has a generally crescent-shaped surface with spaced optical outputs located along the surface. In practice the device would be applied for an extended period of time. Examples of compositions and devices of BriteSmile, Inc. are found in U.S. Pat. Nos. 5,645,628, 5,713,738, 6,162,055, 6,254,388, 6,343,933, 6,416,319 and D438,622 and in published patent application U.S. 2002/0137001. Other U.S. patents dealing with the whitening of teeth are U.S. Pat. Nos. 4,661,070, 4,952,143 and 5,032,178. Typically, where lights have been used to activate the oxidizing agent such lights have been xenon lamps, flash lamps, mercury short arc lamps, metal halide lamps, tungsten halogen lamps, etc.

### SUMMARY OF THE INVENTION

An object of this invention is to provide techniques for speeding the whitening process in a simple and economical manner.

A further object of this invention is to provide such techniques which utilize a toothbrush in connection with creating the whitening effect.

In accordance with this invention an oxidizing agent is provided which may be activated by light and/or heat energy in order to speed the chemical process of whitening stained teeth. The oxidizing agent is applied to the teeth preferably by toothpaste, although other forms of application may be used such as whitening gels, whitening strips or other such products. In the broad practice of this invention an ultraviolet or infrared radiation source is used for directing radiation against the teeth so that the oxidizing agent would be activated.

In a preferred practice of this invention the radiation source is from LED devices incorporated in a toothbrush. The carrier for the oxidizing agent is preferably the toothpaste on the toothbrush cleaning head.

### THE DRAWINGS

FIG. 1 is a side elevational view of a manual toothbrush in accordance with this invention;

FIG. 2 is a front elevational view of the toothbrush shown in FIG. 1; and

FIG. 3 is a front elevational view of a powered toothbrush in accordance with this invention.

### DETAILED DESCRIPTION

The present invention broadly involves applying an oxidizing agent, such as hydrogen peroxide, to a user's teeth. The oxidizing agent or peroxide may be activated by light and/or heat energy in order to speed the chemical process of whitening stained teeth. This can be accomplished through the use of a toothbrush emitting light energy in the form of either ultraviolet radiation or infrared radiation. In the case of infrared energy heating would occur which would accelerate the process. The oxidizing agent could be applied to the teeth in any known manner and could be of any known composition, such as disclosed in the aforenoted patents and application of BriteSmile, Inc., all of the details of which are incorporated herein by reference thereto.

In a preferred practice of this invention the oxidizing agent is incorporated in a toothpaste composition. The invention, however, could also be practiced where the radiation is used to activate or accelerate reactions of specific formulations of whitening gels, whitening strips or other such products.

In contrast to the conventional practices of using various types of lamps the present invention utilizes, in its preferred practice, light energy preferably from LED devices which can be very wavelength specific and much easier to physically place in the norms of typical toothbrush dimensions.

Unlike some previous applications the user, in the practice of this invention, would use the system more frequently for a very short usage period as opposed to the very long infrequent applications of the light energy as with prior techniques. Moreover, many applications in the past have required professional supervision. In contrast the present invention has the benefit of light energy that could be applied by the user in the user's home.

The benefit of incorporating the oxidizing agents in toothpaste is that the oxidizing agents would be applied through the brushing of one's teeth which would be reasonably easy and familiar to all users. The activation of the oxidizing agents could thus occur through use of a special toothbrush, as later described, in which UV or infrared light is allowed to be transmitted through the bristle field of the toothbrush.

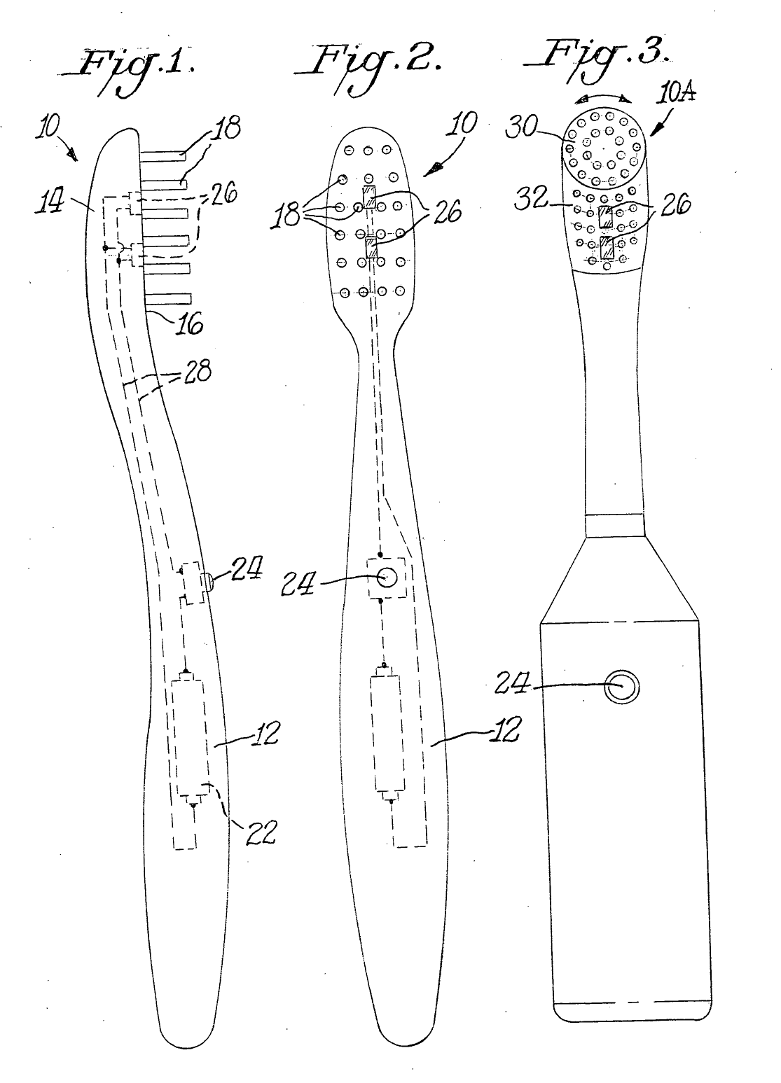

FIGS. 1-2 show a manual toothbrush 10 that may be used in accordance with this invention. As shown therein the toothbrush 10 includes a hollow handle 12 and a cleaning head 14. Cleaning head 14 has an outer surface 16 from which a plurality of cleaning elements 18 extend outwardly. Cleaning elements 18 may be of any suitable form such as bristles or elastomer members of any size or shape. The cleaning elements may also be a combination of different types of cleaning elements. The cleaning elements 18 are arranged on the outer surface 16 of the cleaning head to form a cleaning field.

Mounted within the hollow handle 12 is a source 20 of ultraviolet light. Any suitable source may be used such as miniature UV bulbs as manufactured by Welch Allyn. Although miniature UV bulbs may be used this is a less preferred practice of the invention in that generally such bulbs are of relatively large size with high power consumption and tend to emit undesired UVB radiation. A more preferred practice of the invention would be the use of LEDs for emitting ultraviolet light. A particular advantage of LEDs is that they can be surface mounted. In addition LEDs would have small or low power consumption and provide tight emissions in a tight spectrum band with minimum power requirements and have relatively low intensity. The LEDs could preferably have a safe UVA wavelength of 350-410 nm and more preferably a wavelength of 378-383 nm. Suitable LEDs can be obtained from Roithner Lasertechnik of Vienna, Austria. A suitable LED would be a 3.0×2.2×1.5 nm 3TOP LED. Whatever form of source is used, care should be taken to control the intensity of the UV radiation in order to avoid possible negative health effects.

Although the ultraviolet light can constantly be emitted, it is preferable that the light source be selectively actuated. Any suitable structure could be used for accomplishing that task. FIGS. 1-2, for example, show the hollow handle 12 to include a battery 22 electrically connected by suitable wiring 28 to the surface mounted LED devices 26. A switch 24 located externally on the handle 12 selectively actuates the LEDs.

When the light source is actuated by switch 24 the light is from at least one emitter 26 in the carrier field. The light could be transmitted in any suitable manner by transmitting structure such as a light pipe, fiber optic, or other suitable devices. Preferably, the light(s) or emitters 26 are surface mounted LEDs and are located in the carrier field. The invention, however, could be practiced where the emitters are located elsewhere on the toothbrush instead of or in addition to the carrier field.

In one use of toothbrush 10 toothpaste would be applied to the outer ends of the cleaning elements 18, such as bristles. The toothpaste would incorporate the oxidizing agents, such as hydrogen peroxide. In the normal use of the toothbrush the toothpaste would be applied to the teeth. Either during or immediately after the brushing the user would actuate the ultraviolet light source through switch 24 to radiate the ultraviolet light from the LED emitters 26 toward the teeth. The oxidizing agent would be activated to speed the chemical process of whitening the teeth. Because of the short time required in practicing the invention the procedure could be repetitively performed and over time should result in an effective whitening action. This would have a benefit over conventional practices in being more convenient to use.

Although FIGS. 1-2 illustrate the toothbrush to be a manual toothbrush it is also possible to practice the invention with a powered toothbrush 10A as shown in FIG. 3. In that embodiment the powered toothbrush includes a moveable section 30 in the cleaning field. Movable section 30 could be of any size or shape and could be moved in any known manner such as continuous rotation in one direction, oscillating rotation or linear back and forth and/or side to side movement. One example of movement is an oscillating back and forth rotational movement such as disclosed in U.S. Pat. No. 5,625,916, all of the details of which are incorporated herein by reference thereto. In the illustrated embodiment toothbrush 10A includes in its cleaning field a fixed portion 32 which does not move but which also contains cleaning elements. For the sake of simplicity the LED emitters 26 are located only in the fixed portion 32 rather than having to account for the movability of the LED wiring if the LEDs were also located in the movable section 30. It is, however, in the scope of this invention that the LEDs could be in either the movable section 30 and/or the fixed section 32.

The invention could be practiced where the same switch 24 actuates both the light source and the drive mechanism for the movable section 30. Alternatively, the movable section and the light source could be actuated by separate switches.

Thus, the toothbrush used in the practice of the invention could be a powered toothbrush type, i.e. a toothbrush in which there is movement of the bristles created by a motor and a drive transmission, or a manual toothbrush in which there is no driven movement of the bristles by a power source other than the user. The manual toothbrush would have the light source and the power supply for the light contained inside the brush handle with an external structure, such as a switch 24, for turning on the light. However, the tufts of bristles 18 would remain relatively stationary as is common in manual toothbrushes. Where the toothbrush is a powered toothbrush the LEDs could be turned on by the same switch which activates the power or could be turned on from a separate switch. The LEDs could be located in a movable section of the powered toothbrush or in a fixed section.

1. A toothbrush for creating a whitening effect on a user's teeth, comprising a handle, a cleaning head attached to said handle, said cleaning head having an outer surface, cleaning elements on said cleaning head extending outwardly from said outer surface, said cleaning elements being located in a cleaning field, and said toothbrush having a source of radiation for emitting light energy toward the user's teeth for activating an oxidizing agent on the user's teeth to create a whitening effect.

2. The toothbrush of claim 1 wherein said handle is hollow, said source of radiation including a power supply in said handle, and a switch mounted externally on said handle for selectively actuating said power supply.

3. The toothbrush of claim 2 wherein said light energy is emitted from said cleaning field.

4. The toothbrush of claim 2 wherein said light is emitted from at least one LED.

5. The toothbrush of claim 4 wherein said at least one LED is surface mounted to said toothbrush.

6. The toothbrush of claim 5 wherein said at least one LED has a wavelength of 720-1550 nm.

7. The toothbrush of claim 5 wherein said at least one LED has a wavelength of 350-410 nm.

8. The toothbrush of claim 1 wherein said toothbrush is a manual toothbrush.

9. The toothbrush of claim 8 wherein said source of radiation is selectively actuated by a switch on said handle.

10. The toothbrush of claim 1 wherein said toothbrush is a powered toothbrush having a movable cleaning element carrying section in said cleaning head.

11. The toothbrush of claim 10 wherein said source of radiation is selectively actuated by a switch on said handle.

12. The toothbrush of claim 11 wherein said switch also actuates said movable section.

13. The toothbrush of claim 10 wherein said cleaning head also includes a non-movable fixed section having cleaning elements, and said light energy is emitted from said fixed section.

14. The toothbrush of claim 1 wherein said light energy is emitted from plural locations in said cleaning field.

15. The toothbrush of claim 1 wherein at least some of said cleaning elements are bristles

16. A method for whitening a user's teeth comprising applying an oxidizing agent to the teeth, applying the carrier to the user's teeth, attaching the brightener to the user's teeth, radiating energy from a source in a toothbrush toward the user's teeth, and activating the oxidizing agent from the energy to create a whitening effect.

17. The method of claim 16 wherein the energy is emitted from at least one LED in the toothbrush.

18. The method of claim 17 wherein the oxidizing agent is in toothpaste applied to the toothbrush.

19. The method of claim 17 wherein the source of radiation is selectively activated by a switch.

20. The method of claim 17 wherein the toothbrush is a manual toothbrush.

21. The method of claim 17 wherein the toothbrush is a powered toothbrush.
